(19) United States
(12) Patent Application Publication
(10) Pub. No.: US 2022/0383261 A1
(43) Pub. Date: Dec. 1, 2022

(54) EVENTWEB TECHNOLOGY

(71) Applicant: Ryan Golden, Islip, NY (US)

(72) Inventor: Ryan Golden, Islip, NY (US)

(21) Appl. No.: 17/330,640

(22) Filed: May 26, 2021

(51) Int. Cl. G06Q 10/10; G06Q 30/06; G06F 9/451; G06Q 40/00

(52) U.S. Cl. CPC G06Q 10/1053; G06Q 30/0645; G06F 9/453; G06Q 40/12

(57) ABSTRACT

A software that serves as a one-stop-shop for job seekers, exhibitors, event managers, producers, virtual event producers, freelancers, independent contractors, and industry suppliers in the tradeshow industry or the corporate event industry is described herein. The software that assists users in the tradeshow and corporate event industry with posting help wanted ads, browsing resumes, posting resumes, creating a resume using a resume wizard, viewing job openings, searching directories, posting or searching for promotions, and/or creating or submitting a request for proposal (RFP).

### FIELD OF THE EMBODIMENTS

The field of the invention and its embodiments relate to a software that serves as a one-stop-shop for job seekers, exhibitors, event managers, producers, virtual event producers, freelancers, independent contractors, and industry suppliers in the tradeshow and corporate event industry. In particular, the field of the invention and its embodiments relate to a software that assists users in the tradeshow and corporate event industry with posting help wanted ads, browsing or posting resumes, creating a resume using a resume wizard, viewing job openings, searching producer, freelancer, independent contractor, and industry supplier directories, posting or searching for promotions, and/or creating or submitting a request for proposal (RFP).

### BACKGROUND OF THE EMBODIMENTS

A tradeshow or a corporate event is an exhibition for companies in a specific industry to showcase and demonstrate their new products and services. Generally, tradeshows are not open to the public and can only be attended by company representatives. If a company is producing or planning a tradeshow in a new town, the company may search for exhibitors, event managers, producers, virtual event producers, freelancers, independent contractors, and/or industry suppliers to assist the company via a classified advertisements website or job board, such as craigslist, exhibitmatch.com, or https://www.tradeshowjobboard.com/, among others. However, these sources are often difficult to navigate and do not provide all of the data necessary in an organized and easily filterable manner for hiring individuals or companies. These sources do not provide the data in such a way that will allow users to hyper-focus their search within this industry, as is provided by the present invention.

Additionally, an RFP may be needed, which is a document that solicits a proposal, often made through a bidding process, by an agency or company interested in the procurement of a commodity or service to potential suppliers to submit business proposals. An RFP is used where the request requires technical expertise, specialized capability, or where the product or service being requested does not yet exist, and the proposal may require research and development to create whatever is being requested.

Effective RFPs typically reflect the strategy and short/long-term business objectives, providing detailed insight upon which suppliers will be able to offer a matching perspective. However, RFP's are often difficult to draft properly if one does not have expertise or experience doing so. Specifically, many smaller companies have difficulty understanding everything involved in the creation of an event. From budgets, to design and function, it is difficult for an exhibitor or event manager not very experienced in the event industry to effectively communicate their needs to a producer.

Thus, what is needed is a software that serves as a one-stop-shop for job seekers, exhibitors, event managers, producers, virtual event producers, freelancers, independent contractors, and industry suppliers in the tradeshow industry, allowing these users to post help wanted ads, browse or post resumes, create a resume using a resume wizard, view job openings, search producer, freelancer, independent contractor, and industry supplier directories, post or search for promotions, submit a custom RFP, and/or create or submit the RFP. Moreover, what is needed is a more effective solution that makes the decision process easier for job seekers, exhibitors, event managers, producers, virtual event producers, freelancers, independent contractors, and industry suppliers who are seeking individuals and/or companies for jobs and/or employment opportunities in the tradeshow industry or the corporate event industry. The present invention meets and exceeds this shortcoming in the technical field.

### EXAMPLES OF RELATED ART INCLUDE

CA2680960A1 describes a computer-implemented method, a computer-readable medium, and a system for automatically generating at least a portion of an electronic RFP document. In general, the RFP document is specific to a project based on project-defining information. In one embodiment, the document is automatically generated by associating at least some of the project-defining information with pre-defined criteria selected from a stored collection thereof, interpreting the associated information in accordance with encoded rules interrelating the collection of criteria with a corresponding collection of stored text-based objects to automatically select a subset thereof for incorporation into the RFP document portion, and generating the RFP document portion in accordance with a pre-defined RFP document template incorporating therein the selected subset of text-based objects.

JP 2010/015445 A describes an RFP creation support program.

U.S. Pat. No. 10,810,643 B2 describes a method and system for RFP response generation. The system automatically generates at least one search query in response to an RFP received as input, searches in at least one reference solution database using the generated search query, finds matching data, filters the matching data based on RFP parameter specific data, and prepares a response document. The response document is then provided as an output of the system in response to the RFP collected as input.

U.S. Pat. No. 10,713,425 B2 describes a system for generating a draft proposal. During operation, the system obtains a schema that represents a general model of an RFP. The system generates a structured RFP from an RFP document by structuring elements of the RFP document in the structured RFP based on the schema. The system then generates a proposal outline comprising sections. A respective one of the sections corresponds to one of the elements. The system obtains a piece of content for a respective section of the sections based on a requirement specified in an element corresponding to the section and inserts the piece of content in the section of the proposal outline.

U.S. Published Patent Application No. 2019/0394238 A1 describes techniques for automating/streamlining the process of responding to a security/privacy RFI/RFP as well as monitoring the security/privacy/IT compliance of an organization.

WO 2012/037477 A2 describes a method for managing an RFP. The method includes: receiving, at a website, information about the RFP from a customer for the RFP and receiving, at the website, proposals responsive to the RFP from a set of bidders. If requested by the customer, the method includes disclosing to each of the bidders a detailed comparative metric relating to the proposal for each of the other bidders.

U.S. Published Patent Application No. 2012/0041769 A1 describes an RFP management system that improves the process of matching researchers with relevant research projects as described in RFPs. The system creates a researcher profile based on a scan of the researcher's reports and past proposals, scans, web-based, and other databases for project opportunities that fit the profile, and produces a subset of RFPs for the researcher or an agent to consider. The system includes search and matching features that enable identification of expertise among researchers based on the profile content to facilitate collaboration, and to suggest research teams with the best-matched expertise for each RFP. User interfaces allow researchers to refine their profiles and give feedback to allow the system to learn and improve performance. The system also can be adapted for any application where objects with common features are to be matched and presented or visualized.

WO 2021/026034 A1 describes a method of job recommendation. The method uses machine learning based on actual and synthetic job position related training data.

U.S. Published Patent Application No. 2005/0278300 A1 describes a specialized system that exploits a network by employing an aggregate system to facilitate the provision of positions—/help-wanted and related information. The specialized system includes a plurality of nonspecific sites linked via a network, and a server, connected to the network, for hosting a dedicated site devoted to positions-wanted and help-wanted information. The server reposits dedicated-site interfaces, databases, and control systems. The interfaces carry positions-wanted and help-wanted information, and are open to the network and browsable by stationary and mobile communications devices.

U.S. Published Patent Application No. 2015/0006422 A1 describes a computer-based system for presenting employment analysis and recommendation using an employment matching server system, operatively coupled to a public network. The employment matching server system is configured to: receive a job seeker's data and generate a job seeker's profile, receive an employer's data and generate a true employer's profile and calculate a compatibility value generated from correlating the job seeker's profile with the true employer's profile, such correlation resulting in a potential match if the compatibility value meets or exceeds a predetermined threshold. In the event of a potential match, the employment matching server system is configured to: present the data associated with the employer and the true employer's profile to the job seeker based on one or more of the compatibility values, and present the data associated with the job seeker and the job seeker's profile to the employer based on one or more of the compatibility values. A user interface device may be used to enable the job seeker and the employer to evaluate the potential match.

WO 2010/151062 A2 describes a method for an online job service using a video resume creation wizard program. The reference provides a video resume creation wizard program improving disadvantages of job service using the Internet supporting a recruitment process through a general video resume or job documents to simultaneously show the job documents and the video, such that a job-hunter who is an individual member can easily create the video resume efficiently expressing himself/herself and an employer who is a company member can create promotional video providing more detailed information on duties, thereby making it possible to register hiring information.

Some similar systems exist in the art. However, their means of operation are substantially different from the present disclosure, as the other inventions fail to solve all the problems taught by the present disclosure.

### SUMMARY OF THE EMBODIMENTS

The present invention and its embodiments relate to software that serves as a one-stop-shop for job seekers, exhibitors, event managers, producers, virtual event producers, freelancers, independent contractors, and industry suppliers in the tradeshow and corporate event industry. In particular, the field of the invention and its embodiments relate to a software that assists users in the tradeshow and corporate event industry with posting help wanted ads, browsing or posting resumes, creating a resume using a resume wizard, viewing job openings, searching producer, freelancer, independent contractor, and industry supplier directories, posting or searching for promotions, and/or creating or submitting a request for proposal (RFP).

A first embodiment of the present invention describes a computer system. The computer system comprises one or more processors, one or more memories, and one or more computer-readable hardware storage devices. The one or more computer-readable hardware storage devices contain program code executable by the one or more processors via the one or more memories to implement a method for generating an RFP using an RFP wizard. The method includes numerous process steps, such as: prompting a user to answer a first set of questions regarding general considerations for a tradeshow. The first set of questions regarding the general considerations for the tradeshow include: a name of the company exhibiting at the tradeshow, the tradeshow that's being attended, a location of the tradeshow, the convention center/venue where the tradeshow is taking place, the opening date of the tradeshow, the closing date of the tradeshow, a web site associated with the tradeshow, the general contractor of the tradeshow, whether the user has a confirmed exhibit space at the tradeshow, whether the user has a booth number for the tradeshow, and/or whether this is the user's first year attending the tradeshow.

The method also includes prompting the user to answer a second set of questions regarding general exhibit information for the tradeshow. The second set of questions regarding the general exhibit information for the tradeshow include a size of an exhibit, a format of the exhibit, and/or a type of the exhibit. The type of the exhibit includes a custom exhibit, a rental exhibit, a portable exhibit, or a hybrid custom/rental exhibit.

Next, the method includes prompting the user to answer a third set of questions regarding exhibit functionality and requirements for the tradeshow and prompting the user to answer a fourth set of questions regarding audio visual and overhead banner/lighting requirements for the tradeshow. The third set of questions regarding the exhibit functionality and requirements for the tradeshow include whether the user requires a private meeting room, whether the user requires any standard height meeting tables, whether the user requires bar-height tables, whether the user requires any dedicated storage area, whether the user requires a reception desk or podium, whether the user requires any display areas for products, what type of flooring the user would like, and/or whether the user is displaying any large items. The fourth set of questions regarding the audio visual and overhead banner/lighting requirements for the tradeshow include inquiring if the user needs equipment for the tradeshow. The equipment includes: a monitor, a large format video wall, a computer, a presentation provision, an overhead banner, and/or overhead lighting.

Then, the method includes: prompting the user to answer a fifth set of questions regarding design style considerations for the tradeshow. The fifth set of questions regarding the design style considerations for the tradeshow include: whether there is a hotel the user has been to whose design style the user likes, whether there is an existing brand the user likes, whether there is an existing design style the user would like emulated, whether the user has a style guide or a website, and/or whether the user has brand guidelines or other marketing materials.

The method also includes prompting the user to input a budget for the tradeshow or engage a budget calculator module to determine the budget for the tradeshow. The budget calculator module prompts the user to input a first budget for physical elements of an exhibit and a second budget for event services of the exhibit. The physical elements of the exhibit include: a wall, a floor covering, a piece of furniture, a graphic, a banner, and/or a display. The event services of the exhibit include: freight and handling services, installation and dismantling services, supervision services, drayage services, and/or electrical services. In examples, the RFP wizard also includes a budgetary tips section configured to provide the user with average cost expectations for aspects of the exhibit.

Next, the method includes: preparing an RFP based on the answers to the first, second, third, fourth, and fifth sets of questions. The method then includes allowing the user to download the RFP in any format the user desires (e.g., PDF, text, word, etc.). In some implementations, the user may download the RFP in a zip format. The user may then save and store this RFP how the user desires. The user may submit the RFP to producers or others they find in the event industry from a producer directory.

A second embodiment of the present invention describes a system. The system includes software executable on a first computing device and configured to interact with a database. The software includes one or more modules. The system also includes a second computing device associated with a user and configured to interact with the first computing device.

In an example, the software includes a login module, a registration module, a get listed module, a help wanted module, a budget calculator module, a promotions module, a directory module, an RFP wizard module, and/or a submit an RFP module. The help wanted module comprises a promotions module, a browse a resume module, a post a resume module, a view job openings module, and/or a resume wizard module.

The resume wizard module allows the user to create a customized resume that is hyper-focused on the tradeshow and corporate event industry. For example, the resume wizard module is configured to prompt the user to answer questions, such as: a name of the user, a position the user is looking for, a highest level of education the user has completed, a preference/flexibility of the user regarding working from home and/or in an office, a user's willingness to relocate, a user's willingness to travel, a desired compensation type for the user, a desired salary range for the user, a home address of the user, program/software experience of the user, a user preference for healthcare, a user preference for retirement benefits, and/or types of languages spoken by the user and fluency in each. Upon receiving answers to the questions, the resume wizard module allows the user to download the resume in any format the user desires (e.g., a zip file, PDF, text, word, etc.). The user may then save and store this resume how the user desires. The user may submit the resume to others they find in the event industry from a producer directory.

The promotions module assists the user in posting promotions and/or searching various posted promotions. The promotions module is a means for producers, virtual producers, industry suppliers, and/or freelancers/independent contractors to run promotions. The promotion may be posted for a defined time period based on the cost paid by the user. In some examples, the promotions module is configured to prompt the user to answer questions, such as: a name of a company, an address of the company, a location of a corporate headquarters for the company, a contact email of the company to send resumes to, a position title, a position description, a website associated with the company, social media links for the company, and/or a position location.

Further, the directory module includes a producer directory, a freelancer/independent contractor directory, a virtual event producer directory, and an industry supplier directory. The directory module of the present invention allows the user to hyper-focus their search within this industry to find the right individuals or companies for the job.

### BRIEF DESCRIPTION OF THE DRAWINGS

FIG. 1 depicts a block diagram of a webpage of a system, the webpage comprising a registration module and a login module, according to at least some embodiments disclosed herein.

FIG. 2 depicts a block diagram of a webpage of a system, the webpage comprising a get listed module, a help wanted module, a budget calculator module, and a promotions module, according to at least some embodiments disclosed herein.

FIG. 3 depicts a block diagram of a webpage of a system, the webpage comprising a help wanted module, according to at least some embodiments disclosed herein.

FIG. 4 depicts a block diagram of a webpage of a system, the webpage comprising a directory search module, according to at least some embodiments disclosed herein.

FIG. 5 depicts another block diagram of a webpage of a system, the webpage comprising a directory search module, according to at least some embodiments disclosed herein.

FIG. 6 depicts a block diagram of a webpage of a system, the webpage comprising a submit an RFP module and an RFP wizard module, according to at least some embodiments disclosed herein.

FIG. 7 depicts a block diagram of a webpage of a system, the webpage comprising a promotions module, according to at least some embodiments disclosed herein.

FIG. 8 depicts a block diagram of a computing device used within a system, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

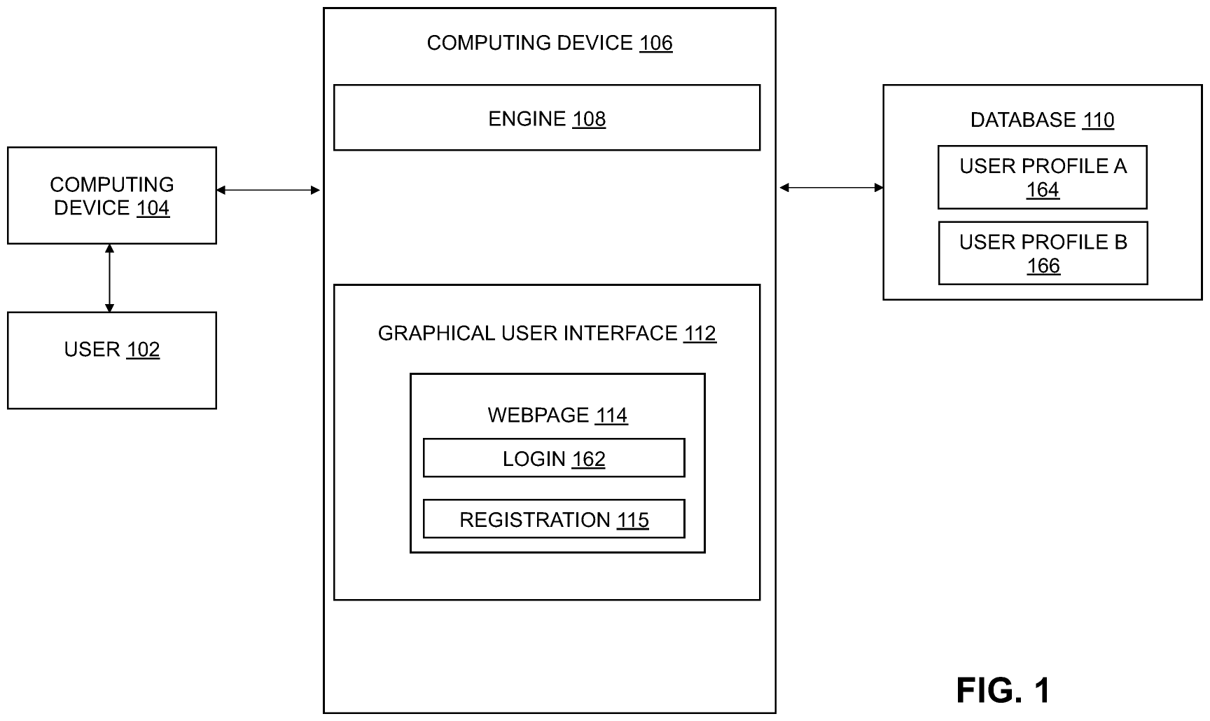

FIG. 1 depicts a block diagram of a webpage of a system, the webpage comprising a registration module and a login module, according to at least some embodiments disclosed herein.

A computer system configured to implement one or more methods described herein is depicted in FIG. 1. The computer system of FIG. 1 includes a computing device 106 and another computing device 104 associated with a user 102. Each of the computing device 106 and the computing device 104 of FIG. 1 may be a computer, a laptop computer, a smartphone, and/or a tablet, among other examples not explicitly listed herein. The computer system of FIG. 1 may also include a database 110 that houses user profiles (e.g., a user profile A 164 and/or a user profile B 166, among others), information, and/or data.

The computing device 106 of FIG. 1 may comprise an engine 108 that may provide a website or webpage (e.g., a webpage 114). In other examples, the engine 108 of FIG. 1 may be an application, a software program, a service, or a software platform configured to be executable on the computing device 106. The webpage 114 may include one or more modules that the user 102 may interact with. For example, as shown in FIG. 1-FIG. 7, the webpage 114 may include a login module 162, a registration module 115, a get listed module 120, a help wanted module 122, a budget calculator module 130, a promotions module 132, a directly search module 124, and/or a submit an RFP module 152, among others not explicitly listed herein.

The user 102 may interact with the computing device 106 via a graphical user interface (GUI) 112 of FIG. 1. If the user 102 has not already registered to use the system described herein, the user 102 may do so via the registration module 115 of FIG. 1. To register, the user 102 may first input their identity/type of account (e.g., a job seeker, an exhibitor or event manager, a producer, a virtual producer, a freelancer/independent contractor, or an industry supplier, etc.).

It should be appreciated that, as described herein, a “job seeker” is an individual that works in any capacity in the event industry. A job seeker can be any individual on the exhibitor side, the producer side, the industry supplier side, or the freelancer/independent contractor side.

As described herein, an “exhibitor” or an “event manager” is a company or individual that exhibits at a tradeshow or hosts a corporate event(s).

As described herein, a “producer” is a company that specializes in producing tradeshow exhibits, events, and event components, as well as corporate events, which may include complete turnkey services (e.g., from conception to completion) or production of specific components of a larger product. Examples of the types of companies associated with the producer category include, but are not limited to, exhibit houses, event production companies, marketing agencies, graphic production houses, mobile display manufacturers, millworkers, labor companies, audio visual suppliers, and staging companies.

As described herein, a “virtual producer” is a company whose main business model is built on providing virtual events for businesses in any capacity. This account type is also for traditional producers who have pivoted into this arena, or who have added this service into their existing line of capabilities.

As described herein, a “freelancer/independent contractor” is an individual who identifies as either a freelancer or an independent contractor. Typically, these individuals focus on one or a few specialties that are related to the event industry. Some examples of freelancers and independent contractors include, but are not limited to, 3D designers, 2D designers, carpenters, labor supervisors, drafters/detailers, copywriters, programmers, truck drivers, and/or social media managers, among others.

As described herein, an “industry supplier” is a business that specializes in providing a specific product, product line, commodity, or service to the event industry. Some examples of product and service types that industry suppliers would be in the business of selling include, but are not limited to, hardware, carpet, furniture, plywood, laminates, freight, storage, lighting, plexiglass, showcases, and/or security devices, among others.

Once the user 102 registers their identity/type of account as described, the user 102 will be prompted to respond to a series of questions. It should be appreciated that the series of questions will differ based on the identity/type of account the user 102 has registered as.

For example, if the user 102 self-classifies as a job seeker, the user 102 may be prompted, by the engine 108, to enter their name, email address, home address, telephone number, positions held in the event industry, a password, etc.

If the user 102 self-classifies as an exhibitor or an event manager, the user 102 may be prompted, by the engine 108, to enter the following information: the business name, the corporate headquarters address, main contact information for the business (e.g., a name, email address, telephone number, etc.), industries the business works in, a website for the business, a password, etc.

If the user 102 self-classifies as a producer, the user 102 may be prompted, by the engine 108, to enter the following information: a company name, a company description, a logo for the company, a main contact for the company (e.g., a name, a title, a telephone number, an email address, etc.), email contacts for where inquires may be sent to, email contacts for where resumes may be sent to, email contacts for where RFPs may be sent to, a main corporate headquarters location, a website for the company, links to videos associated with the company that will be incorporated on the profile associated with the user 102, social media links (including, but not limited to, Facebook, Instagram, LinkedIn, Pinterest, Twitter, Tiktok, Twitch, YouTube, and/or Vimeo), a tier level, a list of states the producer services within the United States, areas the producer services outside of the United States, industries the producer specializes in, capabilities associated with the company, a number of producer locations, locations of United States production facilities, location of production facilities outside of the United States, an age of the company, available rental options (e.g., turnkey exhibit programs, furniture, A/V, computer equipment, metal systems, trusses, portables, overhead banners, etc.), and/or a portfolio, among others.

As described herein, three tiers or categories exist for the “producer.” As described herein, a “Tier 1 Producer” is a company that considers itself one of the biggest and best in the industry, easily able to handle the turnkey production of an exhibit or event of any size, anywhere in the United States and/or outside of the United States.

As described herein, a “Tier 2 Producer” is a mid to large-sized companies, able to handle turnkey production on all but the largest of exhibit and events. Tier 2 Producers may also find themselves sub-contracting for Tier 1 or Tier 3 Producers. Tier 2 Producers may consider their company less “corporate” than the giants of the industry, and may not have production capabilities outside of the United States, or not have them in the United States, if they're an international Producer.

As described herein, a “Tier 3 Producer” may identify as smaller and boutique event and exhibit production companies and agencies. Many of these producers specialize in a particular industry, service type, or service a specific geographic region. Tier 3 Producers may also find themselves subcontracting for Tier 1 and/or Tier 2 Producers. A Tier 3 Producer may also just be very selective about the clients that are taken on, only catering to a handful of great clients. Typically, Tier 3 Producers are also able to offer more cost-effective pricing, as they typically have smaller overheads.

If the user 102 self-classifies as a producer, the user 102 may also have to provide a YES or NO answer to the following questions: (1) is the company a custom retail fixture builder?; (2) does the company provide general contracting services for events?; (3) does the company provide general contracting services for retail/commercial projects?; (4) is the company a union or non-union shop?; (5) is the company willing to sub-contract for other producers?; (6) does the company offer storage options?; (7) does the company have a minimum budget for new clients?; (8) is the company a virtual event provider?; and/or (9) does the company provide courtesy design services? It should be appreciated that these questions are provided for illustrative purposes only. If the user 102 answers YES to question (5), then the user 102 is prompted to answer whether they offer wholesale pricing to resellers. If the user 102 answers YES to question (7), then the user 102 is prompted to select a pricing tier (e.g., more than $5,000, more than $10,000, more than $15,000, etc.).

If the user 102 self-classifies as a freelancer/independent contractor, the user 102 may be prompted, by the engine 108, to input the following information: a company or individual name, a logo, a website associated with the individual or the company, a main contact email, a telephone number, a type of business the freelancer/independent contractor is involved in, an address associated with the freelancer/independent contractor, states the freelancer/independent contractor services within the United States, areas the freelancer/independent contractor services outside of the United States, industries that the freelancer/independent contractor specializes in, capabilities/services offered by the freelancer/independent contractor, program/software skills offered by the freelancer/independent contractor, billing type of the freelancer/independent contractor (e.g., 1099, Corporate Tax ID provided, etc.), a number of years of experience the freelancer/independent contractor has in the field, travel capabilities of the freelancer/independent contractor (e.g., local travel under 30 miles, longer travel between 31-100 miles, road trip travel between 150-300 miles, air travel, travel out of the country, etc.), links to videos of the freelancer/independent contractor, social media links of the freelancer/independent contractor, a portfolio (including images) for the freelancer/independent contractor, etc. The user 102 may also specify whether they accept credit card payments and/or if they work directly with end-users and/or wholesalers to the industry.

If the user 102 self-classifies as a virtual event producer, the user 102 may be prompted, by the engine 108, to input the following information: a company name, a logo, a corporate headquarter address, a website, a phone number, a main contact person (including name, title, telephone number, email address, etc.), email contacts for where inquires may be sent to, email contacts for where resumes may be sent to, email contacts for where RFPs may be sent to, states the virtual event producer services within the United States, areas the virtual event producer services outside the United States, a type of virtual event that the company provides (e.g., producing for individual company virtual experiences, producing large format virtual shows with multiple virtual exhibitors/attendees, producing 3D interactive environments, etc.), industry specializations for the virtual event producer, capabilities of the virtual event producer, videos for the virtual event producer, social media links for the virtual event producer, a portfolio (including images) for the virtual event producer, etc.

If the user 102 self-classifies as the virtual event producer, the user 102 may also be prompted to respond YES or NO to several questions, including, but not limited to: (1) is the company willing to sub-contract for other virtual producers or event producers?; (2) is there a minimum budget for new clients?; and/or (3) does the company have physical event or exhibit production capabilities?

If the user 102 answers YES to question (1), the user 102 may be prompted to answer YES or NO regarding whether the company offers wholesale pricing to resellers. If the user 102 answers YES to question (2), the user 102 may be prompted to specify a pricing tier, such as more than $5,000, more than $10,000, etc.

Next, if the user 102 self-classifies as an industry supplier, the user 102 may be prompted, by the engine 108, to input the following information: (1) a company name associated with the industry supplier, (2) a logo associated with the industry supplier, (3) a website for the industry supplier, (4) a main contact email for the industry supplier, (5) a telephone number for the industry supplier, (6) a corporate HQ address for the industry supplier, (7) product/service categories the industry supplier provides, (8) specific products/services the industry supplier provides, (9) states serviced by the industry supplier within the United States, (10) areas serviced by the industry supplier outside the United States, (11) links to videos associated with the industry supplier, (12) social media links of the industry supplier, and/or (13) a portfolio (including images) for the industry supplier. If the user 102 self-classifies as the industry supplier, the user 102 may also be prompted to answer YES or NO to several questions, such as: does the company sell direct to end-users, wholesale to the industry, or both?

Once registered, the engine 108 may receive, from the user 102, login credentials. The login credentials of the user 102 may include a username, a password, a biometric identification means (e.g., fingerprint identification, face recognition identification, palm print identification, iris recognition, retina recognition, etc.), etc. In response to receiving the login credentials form the user 102, the engine 108 of FIG. 1 may identify the user 102 based on the login credentials. Identification of the user 102 may include a profile associated with the user 102 (e.g., the user profile A 164). The user profile A 164 may include information such as: a name of the user 102, a telephone number of the user 102, an address of the user 102, a resume of the user 102, an ad posted by the user 102, a job opening posted by the user 102, the identity associated with the user 102 (e.g., as the job seeker, as the exhibitor or the event manager, as the producer, as the virtual producer, as the freelancer/independent contractor, or as the industry supplier), a history regarding use of a resume wizard and/or an RFP wizard, etc.

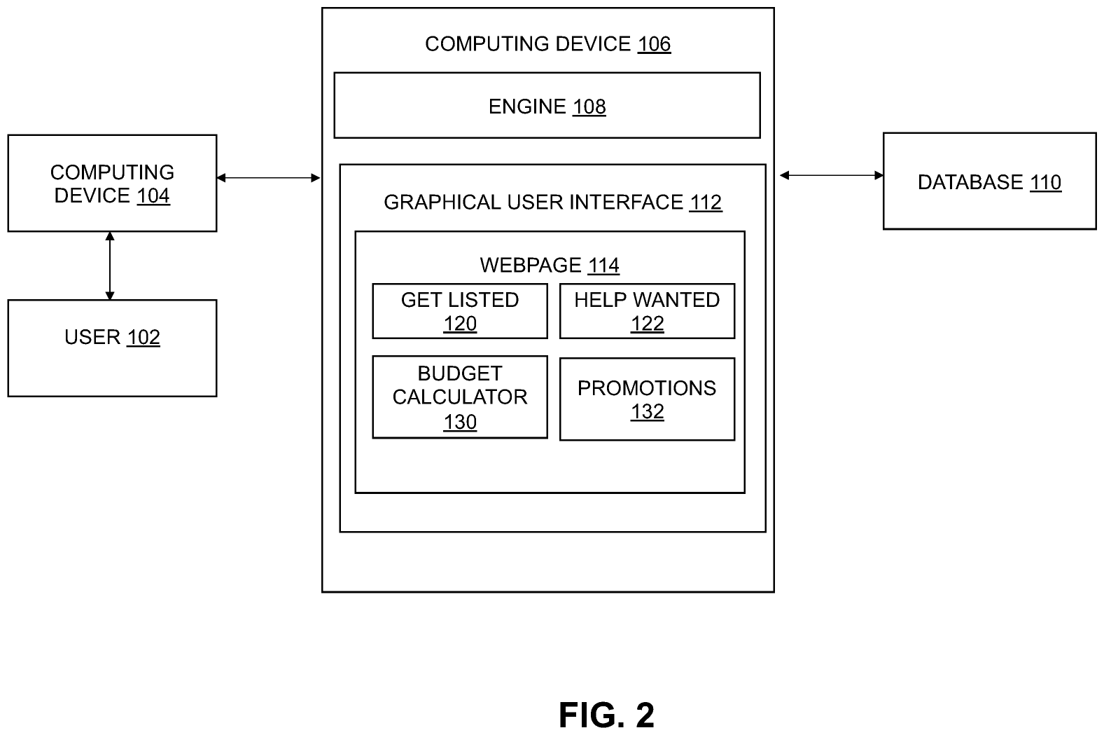

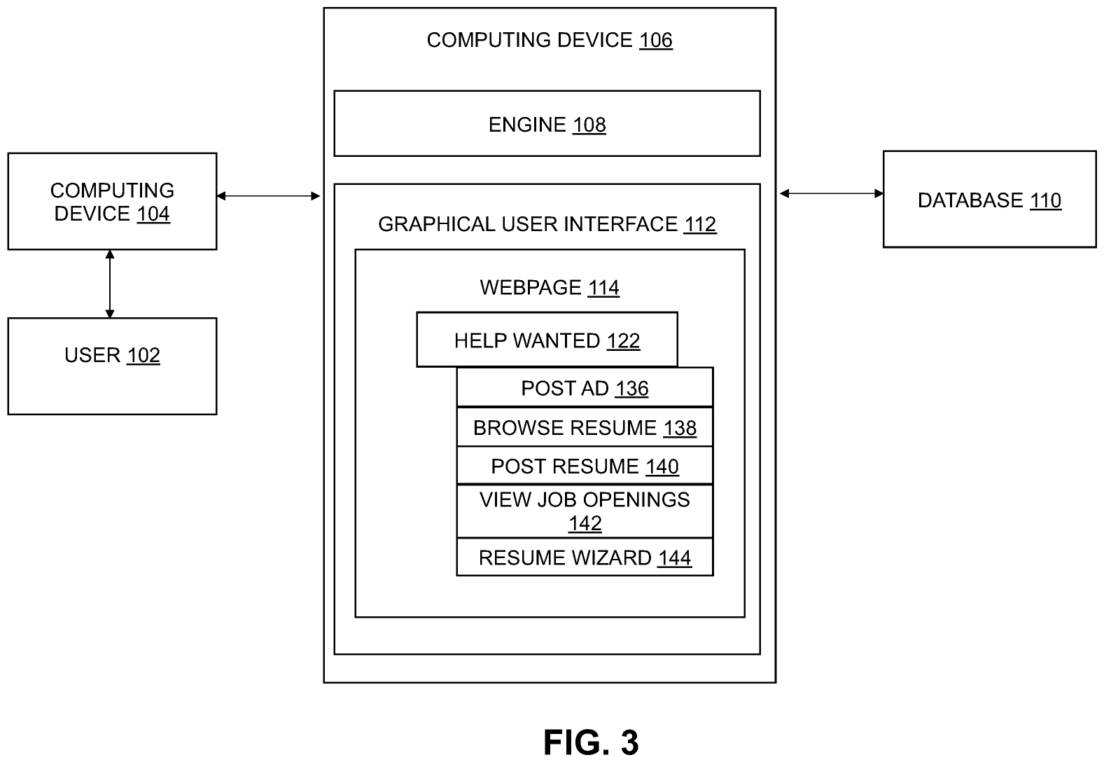

FIG. 2 depicts a block diagram of a webpage of a system, the webpage comprising a get listed module, a help wanted module, a budget calculator module, and a promotions module, according to at least some embodiments disclosed herein. FIG. 3 depicts a block diagram of a webpage of a system, the webpage comprising a help wanted module, according to at least some embodiments disclosed herein.

As shown in FIG. 2, the webpage 114 may display a get listed module 120, a help wanted module 122, a budget calculator module 130, and/or a promotions module 132. As shown in FIG. 3, the help wanted module 122 may allow the user 102 to post an ad 136, browse resumes 138, post a resume 140, view job openings 142, and/or utilize a resume wizard 144.

More specifically, through the help wanted module 122, the user 102 may engage various search filters to view or sort the job openings 142. These search filters include, but are not limited to, a name of a company associated with a job opening, a job location (e.g., city, state, zip code, etc.), a position, a number of years of experience required for the job, program/software knowledge and experience required for the job (e.g., novice, general, intermediate, advanced, master, etc.), a highest level of education required for the job (e.g., on the job training, GED, high school diploma, technical school degree, associate's degree, bachelor's degree, master's degree, PhD, etc.), if a work from hope capability exists, any travel required by the job, a type of compensation for the job (e.g., part time, hourly, salary, commission only, commission with salary, etc.), a salary range for the job, healthcare benefits for the job, retirement benefits for the job, and/or other benefits for the job.

The user 102 may also post a resume 140 and/or utilize the resume wizard 144 via the help wanted module 122, as shown in FIG. 3. Prior to the user 103 posting their resume, the user 102 may be prompted, by the engine 108, to answer a series of questions, such as, but not limited to: a name of the user 102, a position the user 102 is looking for, a highest level of education the user 102 has completed, a preference/flexibility of the user 102 regarding working from home and/or in the office, a user's willingness to relocate, a user's willingness to travel (e.g., number of times per week), a desired compensation type for the user 102, a desired salary range for the user 102, a home address of the user 102, program/software experience of the user 102, a user preference for healthcare, a user preference for retirement benefits, types of languages spoken by the user 102 and fluency in each (e.g., basic, conversational, advanced, main language spoken, etc.), etc.

When engaging with the resume wizard 144 of the help wanted module 122, the user 102 may be prompted to respond to a series of questions to generate a customized resume for the user 102. Once completed, the engine 108 allows the user 102 to download the resume in any format the user desires (e.g., a zip file, PDF, text, word, etc.). The user 102 may then save and store this resume how the user 102 desires. For example, the user 102 may save this resume locally on the computing device 104 and/or in a profile housed on the database 110. The engine 108 also allows the user 102 to submit the resume to others they find in the event industry from the producer directory 126A. In some implementations, the engine 108, if granted authorization by the user 102, may submit the customized resume to a company. Examples of such questions include, but are not limited to, an email address of the user 102, phone number of the user 102, social media profiles of the user 102 (e.g., LinkedIn, Instagram, Facebook, etc.), the user's experience, the user's educational experience and degrees received, a highest level of education the user 102 has achieved, types of languages spoken by the user 102 and fluency in each (e.g., basic, conversational, advanced, main language spoken, etc.), references for the user 102, an introductory title for the user 102, etc.

Additionally, in other examples, the engine 108 may assist the user 102 in creating and posting a help wanted ad 136. The user 102 may be prompted, by the engine 108, to respond to at least the following questions: a name of company, an address of company, a location of the corporate HQ, a contact email to send resumes to, a position title, a position description, a website associated with the company, social media links for the company, a position location, a position (including minimum years of experience required and description of position requirements), program knowledge and experience required for the position, a highest level of education required for the position, an ability to work from home, an amount (if any) of travel required for the position, a compensation type for the position, a salary range for the position, benefits provided by the company (e.g., healthcare and/or retirement), a language requirement and a fluency requirement for the position, etc. Moreover, the help wanted ad 136 may be posted/presented for a defined time period (e.g., 30 days) based on the user's preferences.

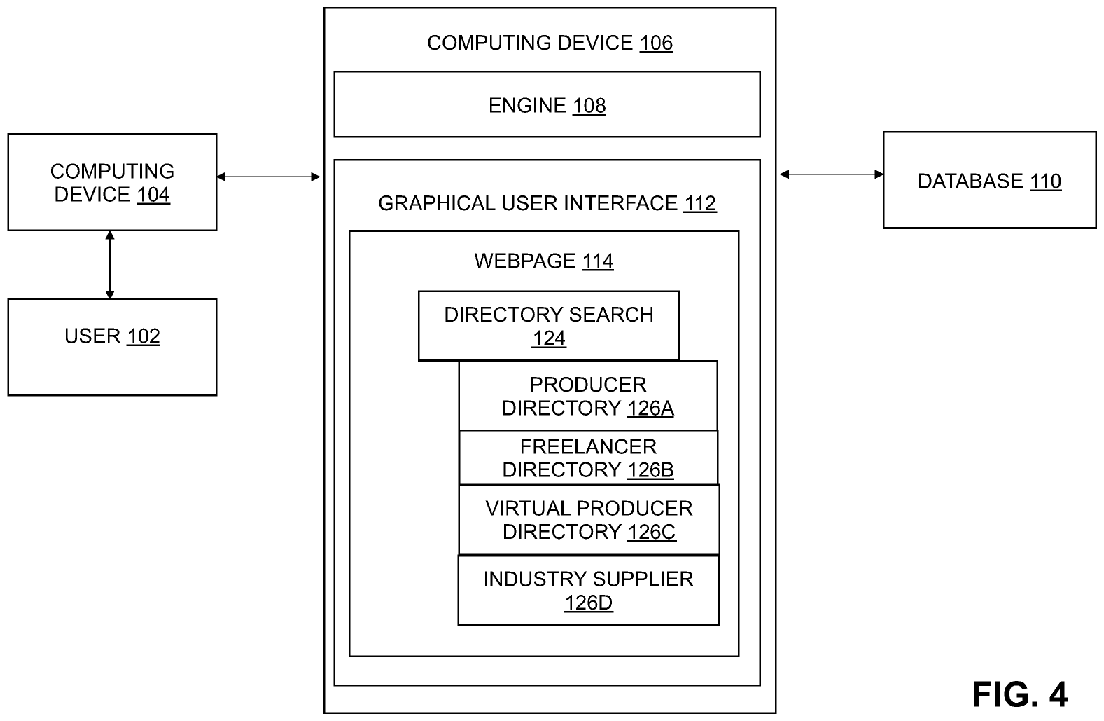

FIG. 4 depicts a block diagram of a webpage of a system, the webpage comprising a directory search module, according to at least some embodiments disclosed herein.

As shown in FIG. 4, the webpage 114 may also host a directory search module 124. The directory search module 124 may allow the user 102 to view and search: a producer directory 126A, a freelancer/independent contractor directory 126B, a virtual event producer directory 126C, and/or an industry supplier directory 126D. Additionally directories may be accessible by the directory search module 124 that are not explicitly described herein. These directories allow all users within the event industry to connect with one another on a meaningful level and enable everyone in the system to find the companies and people they are looking to do business with by giving the users very detailed sorting options so that they can find the perfect partner for whatever their needs may be. It should be appreciated that each user 102 within the directory will have their own profile page that may be stored in the database 110. In some examples, each main directory page may be visited by any user, whether or not that user is logged into the system.

Specifically, the producer directory 126A consists of a search feature to allow a user to explore all producers signed up via this system. The user 102 may search this producer directory 126A by company name, tier level, corporate office location, states serviced within the United States, locations serviced outside of the United States, industry specialization of the company, company capabilities, number of production locations for the company, locations of production facilities for the company, minimum age of the company, available rental options for the company, whether the company has servicing outside of the United Sates, whether the company has custom retail fixture building, whether the company has general contracting services available for events, whether the company provides general contracting services for retail/commercial projects, whether the company is a union or non-union shop, whether the company is willing to sub-contract for other producers, whether the company offers wholesale pricing to resellers, whether there is a minimum budget required for new clients and what that budget is, whether the company has virtual exhibit/event capabilities, and/or whether the company offers storage, among other factors not explicitly listed herein. Once the user 102 selects all preferred options, the engine 108 provides a list of all producers that meet the user-selected requirements. The user 102 may then sort the list by tier or alphabetically by company name.

It should be appreciated that the same capabilities and functionalities of the producer directory 126A are provided for the freelancer/independent contractor directory 126B. The search fields may be identical or substantially similar to those of the producer directory 126A. The search fields for the freelancer/independent contractor directory 126B may include, but are not limited to, a company name, the type of business the freelancer/independent contractor is involved in, an address for the company, states the company services within the United States, areas the company services outside of the United States, industries that the freelancer/independent contractor specializes in, capabilities/services offered by the freelancer/independent contractor, program/software skills offered by the freelancer/independent contractor, billing type of the freelancer/independent contractor (e.g., 1099, Corporate Tax ID provided, etc.), a number of years of experience for the freelancer/independent contractor in the field, travel capabilities of the freelancer/independent contractor (e.g., local travel under 30 miles, longer travel between 31-100 miles, road trip travel between 150-300 miles, air travel, travel out of the country, etc.), etc. In this scenario, once the user 102 selects all options, the engine 108 provides a list of all producers that meet the user-selected requirements. The user 102 may then sort the list alphabetically by company name.

The virtual event producer directory 126C operates similarly to the producer directory 126A and the freelancer/independent contractor directory 126B. The search fields may be identical or substantially similar to those of the producer directory 126A. In some examples, the search fields for the virtual event producer directory 126C may include, but are not limited to, the company name, the states the company services within the United States, areas the company services outside the United States, type of virtual event that the company provides (e.g., producing for individual company virtual experiences, producing large format virtual shows with multiple virtual exhibitors/attendees, producing 3D interactive environments, etc.), industry specializations for the company, company capabilities, etc. The user 102 may then sort the list alphabetically by company name.

The industry supplier directory 126D operates similarly to the producer directory 126A, the freelancer/independent contractor directory 126B, and the virtual event producer directory 126C. The search fields may be identical or substantially similar to those of the producer directory 126A. In examples, the search filters for the industry supplier directory 126D may include, but are not limited to, the company name, the product/service categories the industry supplier provides, specific products/services the industry supplier provides, states the industry supplier services within the United States, areas the industry supplier services outside the United States, etc. The user 102 may then sort the list alphabetically by company name.

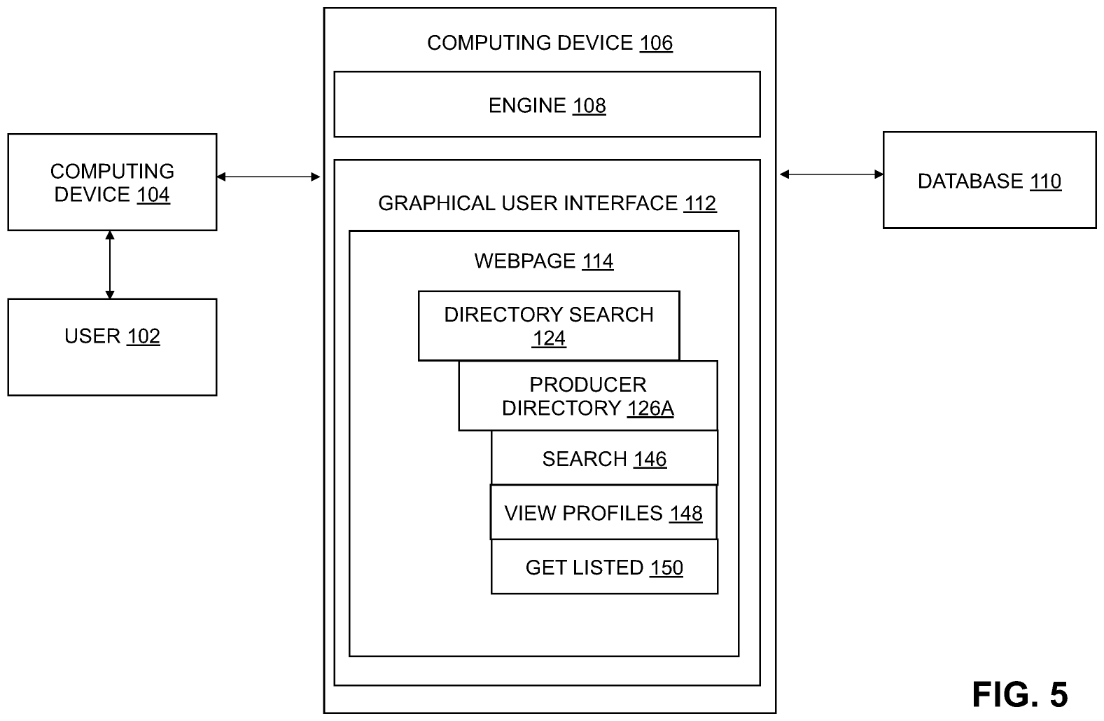

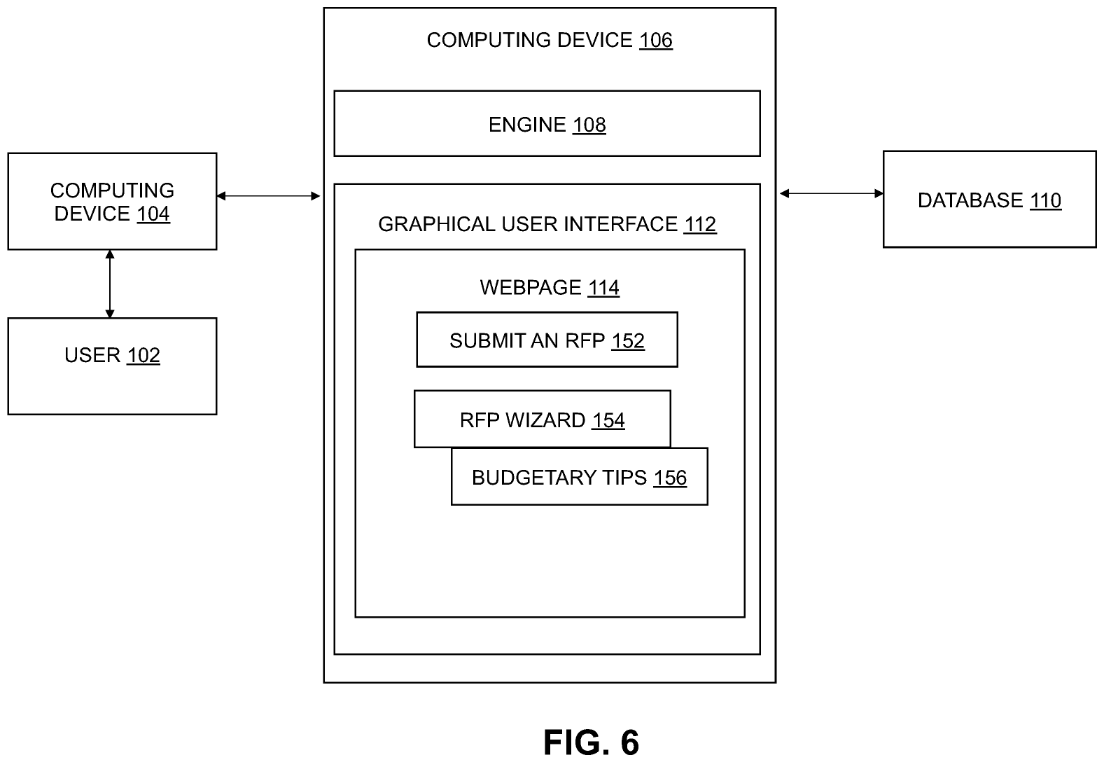

FIG. 5 depicts another block diagram of a webpage of a system, the webpage comprising a directory search module, according to at least some embodiments disclosed herein. FIG. 6 depicts a block diagram of a webpage of a system, the webpage comprising a submit an RFP module and an RFP wizard module, according to at least some embodiments disclosed herein.

As shown in FIG. 5, the user 102 can also search 146, view profiles 148, and/or get listed 150 by engaging any of the producer directory 126A, the freelancer directory 126B, the virtual event producer directory 126C, and/or the industry supplier directory 126D. As shown in FIG. 6, the submit an RFP module 152 allows the user 102 to engage an RFP wizard module 164 and/or view budget tips 156 for the RFP.

Specifically, the RFP wizard module 164 helps businesses that do not necessarily have giant marketing teams that are capable of putting together professional RFPs to submit to producers. Many smaller companies have difficulty understanding everything involved in the creation of an event. From budgets, to design and function, it is difficult for an exhibitor or an event manager not very experienced in the event industry to effectively communicate their needs to a producer. Further, producers are also adversely affected by an exhibitor's inability to properly convey their project requirements. All parties involved are affected, with designs not meeting needs, budgets being overblown, and with time and money wasted by all. Further, the RFP wizard module 164 seeks to use knowledge to take an exhibitor or an event manager through the RFP creation process by asking important and direct questions that will help effectively communicate the businesses' needs to the producers. This will make everyone's lives easier and save all involved time and money in the process.

Specifically, the RFP wizard module 164 will include instructions on use of the RFP wizard module 164. The user 102 may first select a “start” or a “begin” option of the RFP wizard module 164. Then, the user 102 is presented with a list of questions to answer in the RFP wizard module 164. The questions may include the following, among others not explicitly listed herein: a name of the company exhibiting, the show that's being attended, a location of the show, the convention center/venue where the show is taking place in, the opening date of the show, the closing date of the show, a website associated with the show, the general contractor of the show, whether the user has a confirmed exhibit space at this show, whether the user has a booth number for this show, and whether this is the user's first year attending this show. Options for the general contractor of the user include: GES, Freeman, Shephard, GEMS, Champion, or other. The user 102 may then continue on, with the user's progress being saved.

Next, the user 102 may answer questions directly regarding general exhibit information for the trade show exhibit, which may include, among others: a size of the exhibit (e.g., 10 feet to 100 feet), a format of the exhibit (e.g., in-line, walk-through, corner, endcap, island, or other), and whether the user 102 is looking for a custom exhibit, a rental exhibit, a portable exhibit, or a hybrid custom/rental exhibit.

Next, the user 102 may answer questions regarding exhibit functionality and requirements for the tradeshow or the corporate event. The questions may include, among others,

(1) whether the user requires a private meeting room, and if so,
(a) how many rooms are needed?;
(b) should each room be the same size?; and
(c) does the user require a ceiling, lighting control, air conditioning, a refrigerator? etc.;

(2) whether the user requires any standard height meeting tables, and if so,
(a) how many tables are required?;
(b) how many seats are required for each table?; and
(c) does each table require power? etc.;

(3) whether the user requires bar-height tables, and if so,
(a) how many?;
(b) how many bar stools?; and
(c) is power required?

(4) whether the user requires any dedicated storage area, and if so,
(a) what size of storage and what forms of storage are needed by the user?;

(5) whether the user requires a reception desk or podium, and if so,
(a) how many reception desks or podiums are needed?; and
(b) will people be seated or standing at each desk? etc.;

(6) whether the user requires any display areas for products, and if so,
(a) what type of displays are needed (e.g., slatwall, standards, showcases, pedestals, etc.)?; and (b) if security provisions are needed? etc.;

(7) what type of flooring the user would like (e.g., carpet, hardwood, vinyl roll out, no flooring, etc.); and

(8) whether the user is displaying any machinery, cars, or other items the producer would need to account for.

Next, the user 102 may answer questions regarding audio visual and overhead banner/lighting requirements for the tradeshow or the corporate event. Audio visual and overhead work, be it a banner and/or an elaborate lighting truss rig, can represent some of the most important and costly elements of a tradeshow exhibit program or a corporate event program. Additionally, these elements require important physical considerations, which the producer must take into consideration when laying out the users design as early in the process as possible. These questions may include, among others: if the user needs any sort of monitors, large format video walls, computers, laptops, presentation provisions (e.g., microphones, speakers, mixers, etc.), overhead banners, and/or overhead lighting. The questions may also prompt the user regarding a specific quantity of each, purpose for each, location of each, dimensions of each, brand of each, etc.

Then, the user 102 may answer questions regarding design style considerations for the trade show. Creating the perfect overall look and feel of the users exhibit is one of the most challenging tasks a producer can take on. This section seeks to identify the users brand identity and aesthetic, as well as overall style desires. The user 102 may be prompted to select works that relate to the user's overall design aesthetic, such as: modern, clean, futuristic, dark, rustic, etc. The user 102 may also be prompted to answer some questions, including, but not limited to:

(1) Is there a hotel you may have been to whose design style you loved, and would like to emulate?;

(2) Is there an existing brand you love whose aesthetic your producer can look to for inspiration?;

(3) Do you have an existing design style, such as your corporate office, that you would like to emulate?;

(4) Do you have an existing style guide, website, or other marketing material for your brand that you would like your producer to take inspiration from?;

(5) Are there any exhibits you have seen online, at shows, or on producer's portfolios that you would like to emulate?;

(6) Do you have brand guidelines or other marketing material that you can provide?; and

(7) Do you have any additional info regarding your overall aesthetic that you'd like to communicate in this RFP?

Next the budget calculator module 130 of FIG. 2 is an important feature, since providing a budget as accurate as possible to a potential exhibit producer may be the single most important thing that a user can do to ensure the user receives the best possible design for the tradeshow exhibit or a corporate event. Many people think that if you give a producer a real budget, they are just going to make the quote exactly to that number and that the user won't get a great deal. Nothing could be further from the truth. Great producers need that target cost to keep their designers and estimators all working with a specific end-point in mind.

If the user 102 already knows their budget and wishes to proceed without engaging this module, the user 102 may do so. However, if the user 102 would like to engage the budget calculator module 130, the budget calculator module 130 takes into account both (1) the physical exhibit components budget and (2) the event services elements budget.

The physical exhibit components budget prompts the user 102 to answer questions regarding the user's 102 budget for physical elements of the exhibit, such as walls, floor coverings, furniture, graphics, banners, displays, etc. The user 102 may enter the overall budget for all physical elements of the exhibit or may enter budgets for each specific exhibit element (e.g., for the walls, the floor coverings, the furniture, etc.).

For the event services elements budget, the user 102 may enter the overall budget for all event services of the exhibit or may enter budgets for each specific event services (e.g., for freight and handling, installation and dismantling, supervision, drayage, electrical, internet, etc.).

Then, the user 102 may review the budget based on the user's input. Next, the user 102 may upload all elements the producer may need to work on for the exhibit, which may include: logos, marketing materials, style guides, fonts, exhibitor service manuals, images for design inspiration, images of previous exhibits, etc. After the budget calculator module 130 receives this information, the RFP wizard module 164 prepares the RFP for the user 102 to review. Once the user 102 confirms the contents of the prepared RFP, the prepared RFP may be submitted directly to producers that the user 102 finds in the directory (e.g., the producer directory 126A) that meet the users' specific needs. The user 102 may also download the RFP in any format the user 102 desires (e.g., zip format, PDF, word, etc.) and to any location the user 102 desires (e.g., locally).

In some examples, the RFP wizard module 154 of FIG. 6 may also include a budgetary tips section 156. The budgetary tips section 156 of FIG. 6 reflects the average United States pricing trends for various aspects of the exhibit. The pricing in this budgetary tips section 156 may be updated in real-time to provide the most accurate and up-to-date information for the client or the user 102.

The budgetary tips section 156 may also provide the user 102 with cost expectations based on their budget. For example, if the user 102 has a budget of $50/square feet or less (which is considered economical), the budgetary tips section 156 may inform the user 102 that all elements will likely be rentals, it is unlikely to receive any tall walls over the standard 8 feet in height, furniture will be generic, banners provided will be generic, carpet or vinyl flooring is likely, graphics may be simple wraps or boards, a small number of rental monitors may be possible, etc. If the user 102 has a more expansive budget of $100-$150/square foot, the budgetary tips section 156 may inform the user 102 that custom production may be possible for most exhibits, custom hard walls may be achievable in this budget, purchasing furniture is possible, purchasing A/V may be an option, etc.

The budgetary tips section 156 of FIG. 6 may also provide tips for the user 102, such as the user 102 obtaining a copy of the show manual prior to proceeding with this section. This budgetary tips section 156 may also provide typical expenses for freight and handling services, installation and dismantling services, etc. The budgetary tips section 156 may further provide average costs for simple exhibits (e.g., a minimum amount of labor is required), moderately complex exhibits (e.g., less than 2 days of installation is required), elaborate exhibits (e.g., approximately 2 days of installation is required), and very elaborate exhibits (e.g., approximately 3 days of installation is required) based on the average costs of the city in which the exhibit will occur in.

For example, “expensive cities” of this budgetary tips section 156 include New York City, Philadelphia, San Francisco, Chicago, Boston, and Los Angeles. Next, “moderately priced cities” of this budgetary tips section 156 include Las Vegas, Washington, D.C., Miami, and Baltimore. “Inexpensive cities” of this budgetary tips section 156 include Atlanta, Denver, Orlando, New Orleans, and Dallas. As an illustrative example, all costs for a simple exhibit in an expensive city (e.g., New York City) may range between $5,000-$7,000. All costs for the simple exhibit in a moderately priced city (e.g., Las Vegas) may range between $3,000-$5,500. All costs for the simple exhibit in an inexpensive city (e.g., Denver) may range between $2,500-$4,500.

The budgetary tips section 156 of FIG. 6 may also provide the user 102 with information regarding supervision, drayage (e.g., the cost the exhibitor is charged by the show general contractor for several services), electrical requirements (e.g., power requirements, electrical labor requirements, labor to distribute electrical components, installation labor, dismantling labor, etc.), Internet services (e.g., shared wireless Internet vs. dedicated wireless Internet, hardline dedicated Internet services, etc.), rigging/hanging banners, etc.

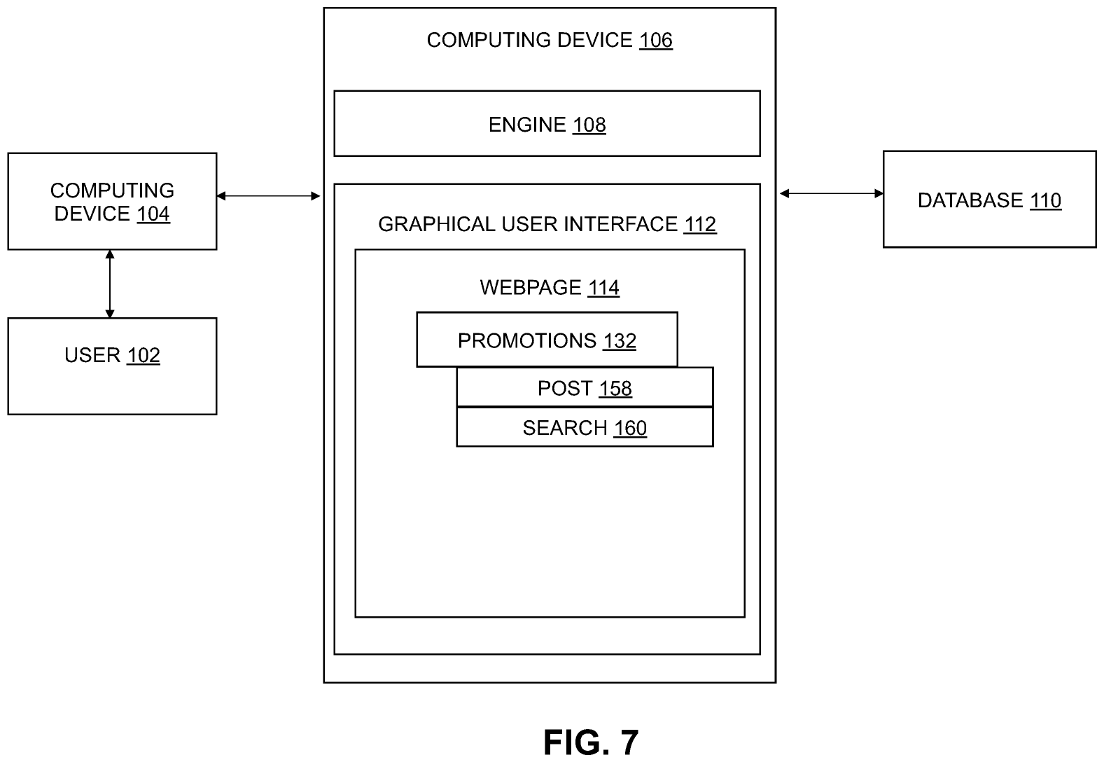

FIG. 7 depicts a block diagram of a webpage of a system, the webpage comprising a promotions module, according to at least some embodiments disclosed herein.

As shown in FIG. 7, the user 102 may engage the promotions module 132 to post a promotion 158 and/or search various posted promotions 160. The promotions module 132 is a means for producers, virtual producers, industry suppliers, and/or freelancers/independent contractors to run promotions. The promotion may be posted for a defined time period based on the cost paid by the user 102. The cost for posting a promotion may be a one-time cost, a monthly cost, a bi-monthly cost, etc. If the user 102 wishes to post a promotion, the promotions module 132 may guide the user 102 in putting the promotion together by asking the user for a business category, a title of the promotion, a description of the promotion, images related to the promotion, a contact email address for the promotion, and an expiration date of the promotion.

As shown in FIG. 7, the user 102 may additionally search 160 for promotions by the following filters: business category of the company posting the promotion, producer name, keyword search, etc. Once the user 102 searches for promotions, the promotions module 132 may provide a search results listing. The user 102 may sort the listing by any option.

The engine 108 may also have an advertising module (not shown), that provides advertisement slots that can be purchased by the user 102 or other users for a defined time period based on the cost paid by the user 102.

Moreover, it should be appreciated that though the system described herein focuses on the tradeshow industry or the corporate event industry, the present system may be used with other industries, such as the custom retail sector, among other industries not explicitly listed herein.

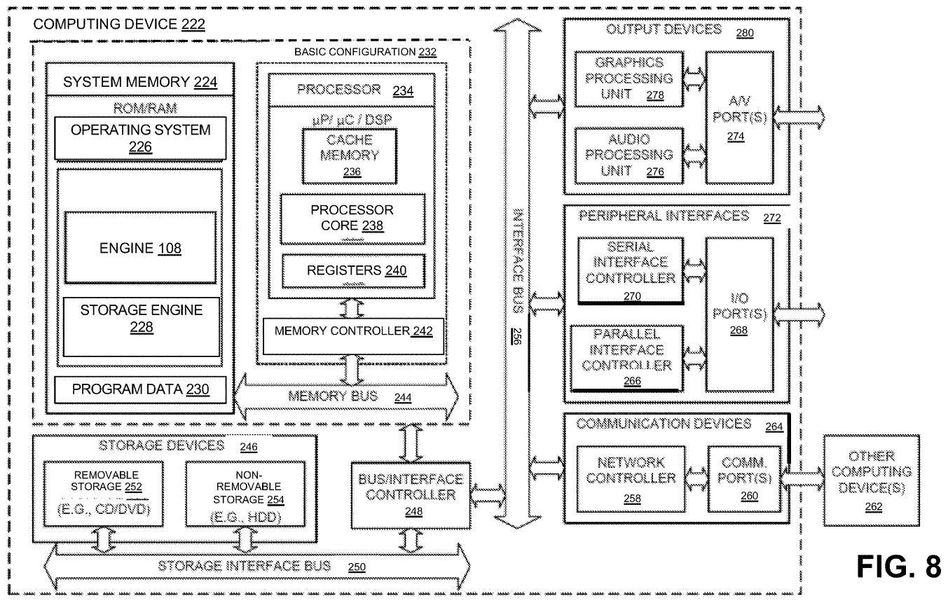

FIG. 8 is a block diagram of a computing device included within the system that is configured to implement one or more methods described herein, in accordance with embodiments of the present invention.

In some embodiments, the present invention may be a computer system, a method, and/or the computing device 106 or the computing device 222 (of FIG. 8). A basic configuration 232 of a computing device 222 is illustrated in FIG. 8 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as an engine 108, and program data 230. In some embodiments, the engine 108 may be an application, a software program, a service, or a software platform, as described infra. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A computer system comprising one or more processors, one or more memories, and one or more computer-readable hardware storage devices, the one or more computer-readable hardware storage devices containing program code executable by the one or more processors via the one or more memories to implement a method for generating a request for proposal (RFP) using an RFP wizard, the method consisting of:
prompting a user to answer a first set of questions regarding tradeshow considerations associated with at least a geographical location of the tradeshow, a convention center or venue where the tradeshow is taking place, an opening date of the tradeshow, a closing date of the tradeshow, a general contractor for the tradeshow, whether the user has a confirmed space at the tradeshow, and whether it is the user's first year attending the tradeshow;
prompting the user to answer a second set of questions regarding general tradeshow exhibit information that include a size of a tradeshow exhibit, a format of the tradeshow exhibit, and a type of the tradeshow exhibit, wherein the type of the tradeshow exhibit is selected from the group consisting of: a custom tradeshow exhibit, a rental tradeshow exhibit, a portable tradeshow exhibit, and a hybrid custom/rental tradeshow exhibit;
prompting the user to answer a third set of questions regarding tradeshow exhibit functionality and requirements that include at least whether the user requires a private meeting room, whether the user requires any dedicated storage area, whether the user requires a reception desk or podium, whether the user requires any display areas for products, and what type of flooring the user would like to use;
prompting the user to answer a fourth set of questions regarding audio visual and overhead banner/lighting requirements for the tradeshow that includes inquiring if the user needs equipment for the tradeshow, wherein the equipment is selected from the group consisting of: a monitor, a large format video wall, a computer, a presentation provision, an overhead banner, and overhead lighting;
prompting the user to answer a fifth set of questions for the tradeshow that comprise whether there is a hotel the user has been to whose design style the user likes, whether there is an existing brand the user likes, and whether the user has brand guidelines or other marketing materials that can be applied to the tradeshow;
prompting the user to engage a budget calculator module to determine the budget for the tradeshow;
prompting the user, by the budget calculator module, to input a first budget for physical elements of the tradeshow and a second budget for services of the tradeshow, wherein the physical elements of the tradeshow comprise at least one wall, a floor covering, at least one piece of furniture, a graphic, a banner, and a display, and wherein the services of the tradeshow comprise freight and handling services, installation and dismantling services, supervision services, drayage services, and electrical services;
providing a budgetary tips section of the RFP wizard that is configured to:
receive, from the user, a location of the tradeshow;
query at least one server or database, in real-time, to identify an average cost estimate for the tradeshow exhibit based on the geographical location of the tradeshow, wherein the average cost estimate for the tradeshow exhibit is higher in a first set of cities than in a second set of cities, wherein the first set of cities arc selected from the group consisting of: New York City, Philadelphia, San Francisco, Chicago, Boston, and Los Angeles, and wherein the second set of cities are selected from the group consisting of: Atlanta, Denver, Orlando, New Orleans, and Dallas;
update the average cost estimate for the tradeshow exhibit in real-time;
compare the cost estimate for the tradeshow exhibit with the user inputted budget;
in response to an identification that the cost estimate for the tradeshow exhibit exceeds the user inputted budget, notify the user that elements of the tradeshow exhibit will be rentals; and
in response to an identification that the cost estimate for the tradeshow exhibit is less than the user inputted budget, notify the user that the elements of the tradeshow exhibit are customizable;
storing the answers to the first, second, third, fourth, and fifth sets of questions in a format in a non-transitory storage device;
receiving, from the user, elements associated with the tradeshow exhibit, wherein the elements associated with the tradeshow exhibit comprise at least a logo, a marketing material, a style guide, an exhibitor service manual, and an image of a previous exhibit;
converting the elements into the format;
preparing an RFP based on the format of the answers to the first, second, third, fourth, and fifth sets of questions and the elements associated with the tradeshow exhibit;
providing the RFP to the user for review via a graphical user interface (GUI) of the computer system;
in response to the user confirming contents of the RFP, allowing the user to submit the RFP to a producer identified in a directory module associated with the computer system, download the RFP locally, or transmit the RFP to a third-party; and
in response to the user rejecting a portion of the contents of the RRP,
allowing the user to update the answers to the first, second, third, fourth, and fifth sets of questions and the elements associated with the tradeshow exhibit in real-time through the GUI;
updating the RFP based on the updated answers to the first, second, third, fourth, and fifth sets of questions and the elements associated with the tradeshow exhibit; and
allowing the user to submit the RFP to the producer identified in the directory module, download the RFP locally, or transmit the RFP to the third-party.

2.-4. (canceled)

5. The computer system of claim 1, wherein the third set of questions regarding the exhibit functionality and requirements for the tradeshow further comprise: whether the user requires any standard height meeting tables, whether the user requires bar-height tables, and whether the user is displaying any large items.

6.-11. (canceled)

12. A system comprising:
software executable on a first computing device and configured to interact with a database, the software comprising one or more modules; and
a second computing device associated with a user and configured to interact with the first computing device.

13. The system of claim 12, wherein the software comprises a module selected from the group consisting of: a login module, a registration module, a get listed module, a help wanted module, a budget calculator module, a promotions module, a directory module, an RFP wizard module, and a submit an RFP module.

14. The system of claim 13, wherein the submit the RFP module allows the user to submit an RFP directly to a producer the user finds in the directory module.

15. The system of claim 13, wherein the help wanted module comprises a promotions module, a browse a resume module, a post a resume module, a view job openings module, and/or a resume wizard module.

16. The system of claim 15, wherein the resume wizard module is configured to prompt the user to answer questions selected from the group consisting of: a name of the user, a position the user is looking for, a highest level of education the user has completed, a preference/flexibility of the user regarding working from home and/or in an office, a user's willingness to relocate, a user's willingness to travel, a desired compensation type for the user, a desired salary range for the user, a home address of the user, program/software experience of the user, a user preference for healthcare, a user preference for retirement benefits, and types of languages spoken by the user and fluency in each.

17. The system of claim 16, wherein, upon receiving answers to the questions, the resume wizard module is configured to:
allow the user to save the resume to a profile on the database, upload the resume directly to a company profile in the database, or download the resume.

18. The system of claim 16, wherein the promotions module is configured to prompt the user to answer questions selected from the group consisting of: a name of a company, an address of the company, a location of a corporate headquarters for the company, a contact email of the company to send resumes to, a position title, a position description, a website associated with the company, social media links for the company, and a position location.

19. The system of claim 13,
wherein the directory module comprises a producer directory, a freelancer/independent contractor directory, a virtual event producer directory, and an industry supplier directory, and
wherein the directory module allows the user to hyper-focus a search within a tradeshow and corporate event industry.
